(19) United States
(12) Patent Application Publication
(10) Pub. No.: US 2005/0171672 A1
(43) Pub. Date: Aug. 4, 2005

(54) Vehicle rollover detection using dual-axis acceleration sensing

(76) Inventor: Edward J. Wallner, Westfield, IN (US)

Correspondence Address: STEFAN V. CHMIELEWSKI;DELPHI TECHNOLOGIES, INC., Legal Staff MC CT10C, P.O. Box 9005, Kokomo, IN, 46904-9005, US

(21) Appl. No.: 10/767,810

(22) Filed: Jan. 29, 2004

(51) Int. Cl. G06F 19/00

(52) U.S. Cl. 701/70; 340/440

(57) ABSTRACT

A rollover sensing apparatus and method are provided for generating a safing (arming) signal for use in vehicle rollover detection. The rollover sensing apparatus includes a first acceleration sensor located on a vehicle and oriented an angle offset from the longitudinal axis and lateral axis of the vehicle, and sensing longitudinal and lateral components of acceleration of the vehicle. The apparatus includes a second acceleration sensor located on the vehicle and oriented at an angle offset from the longitudinal axis and lateral axis of the vehicle, and sensing longitudinal and lateral components of acceleration of the vehicle. The apparatus further includes control logic for determining a safing signal as a function of at least one of the acceleration signals. The safing signal may be used to detect a vehicle rollover and deploy restraint devices.

### TECHNICAL FIELD

The present invention generally relates to rollover sensing and, more particularly to vehicle rollover sensing employing safing (arming) logic for detecting a potential rollover condition of the vehicle.

### BACKGROUND OF THE INVENTION

Automotive vehicles are increasingly equipped with on-board restraint devices that deploy in the event that the vehicle rolls over in an attempt to provide added protection to occupants of the vehicle. For example, a pop-up roll bar can be deployed to extend vertically outward to increase the height of support provided by the roll bar, upon detecting an anticipated vehicle rollover condition. Additionally, many vehicles are typically equipped with multiple air bags, side curtains, and seatbelt pretensioners. These and other restraint devices require timely deployment to mitigate adverse effects to occupants in the vehicle. To achieve timely deployment of restraint devices, the static and/or dynamic conditions of the vehicle generally must be monitored and a decision must be made to determine whether a vehicle rollover is anticipated.

Various single sensor and multiple sensor modules have been employed in vehicles to sense the static and dynamic conditions of the vehicle. For example, tilt switches, tilt sensors, angular rate sensors, and accelerometers have been employed. One sophisticated rollover sensing approach employs up to six sensors including three accelerometers and three angular rate sensors (gyros) generating sensed signals. The sensed signals are processed via an embedded microprocessor, which further discriminates deploy-desired events from non-deploy events. The sophisticated multiple sensor techniques generally employ primary discrimination algorithms implemented in a controller to process the sensed signals and determine the potential for a vehicle overturn condition.

In addition to employing primary rollover discrimination logic, some rollover detection approaches employ safing logic, also referred to as roll arming logic, which generates a safing (roll arming) signal that serves as a redundancy check prior to deploying restraint devices during a potential rollover event. The safing (roll arming) signal is typically logically ANDed with a rollover discrimination signal, to generate a rollover deployment output signal. One example of a vehicle rollover module employing roll arming (safing) control logic is disclosed in U.S. Pat. No. 6,535,800, which is hereby incorporated herein by reference. The aforementioned roll arming (safing) control logic processes angular rate signals generated by a pair of angular rate sensors.

While the aforementioned roll arming (safing) control logic approach is well suited for vehicle rollover detection and restraint device deployment, some drawbacks may exist in that many angular rate sensors typically have a non-zero time-varying output. The resultant bias may cause a significant error in the integrated roll angle. Additional circuitry may be required to minimize the error, which adds to the size and cost of the module.

It is therefore desirable to provide for an accurate and timely responsive rollover safing apparatus that reduces or eliminates drawbacks of conventional approaches. In particular, it is desirable to provide for a cost-effective and accurate rollover safing apparatus that minimizes the probability of inadvertent or unwanted deployment activation with a rollover detection apparatus.

### SUMMARY OF THE INVENTION

In accordance with the teachings of the present invention, a rollover sensing apparatus and method are provided for generating a safing signal for use in vehicle rollover detection. The rollover sensing apparatus includes an accelerometer located on a vehicle and oriented in a first axis at an angle offset from the longitudinal axis and lateral axis of the vehicle. The accelerometer senses a longitudinal component of acceleration of the vehicle and a lateral component of acceleration of the vehicle. The apparatus further includes control logic for receiving the sensed acceleration signal and generating a safing signal as a function of at least one of the longitudinal and lateral components of acceleration.

According to another aspect of the present invention, a rollover sensing apparatus is provided for detecting an anticipated overturn condition of a vehicle. The apparatus includes a sensor for detecting a vehicle roll characteristic, and rollover discrimination logic for generating a rollover discrimination signal. The apparatus also includes an accelerometer located on the vehicle and oriented in a first axis at an angle offset from the longitudinal axis and lateral axis of the vehicle. The accelerometer senses a longitudinal component of acceleration of the vehicle and a lateral component of acceleration of the vehicle. According to one embodiment, the accelerometer is implemented with a dual-axis acceleration sensor having first and second acceleration sensors angularly offset from one another. The apparatus includes safing logic for processing the sensed acceleration signal and generating a safing signal as a function of at least one of the longitudinal and lateral acceleration components. The apparatus further includes control logic for processing the discrimination signal and safing signal and generating a vehicle rollover output signal.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram of a vehicle equipped with a vehicle rollover sensing apparatus for detecting rollover of the vehicle according to the present invention;

FIG. 2 is a block and circuit diagram illustrating the rollover control logic including safing logic according to the present invention; and

FIG. 3 is a flow diagram illustrating a method of generating a safing signal with the rollover safing logic according to the present invention.

### DESCRIPTION OF THE PREFERRED EMBODIMENT

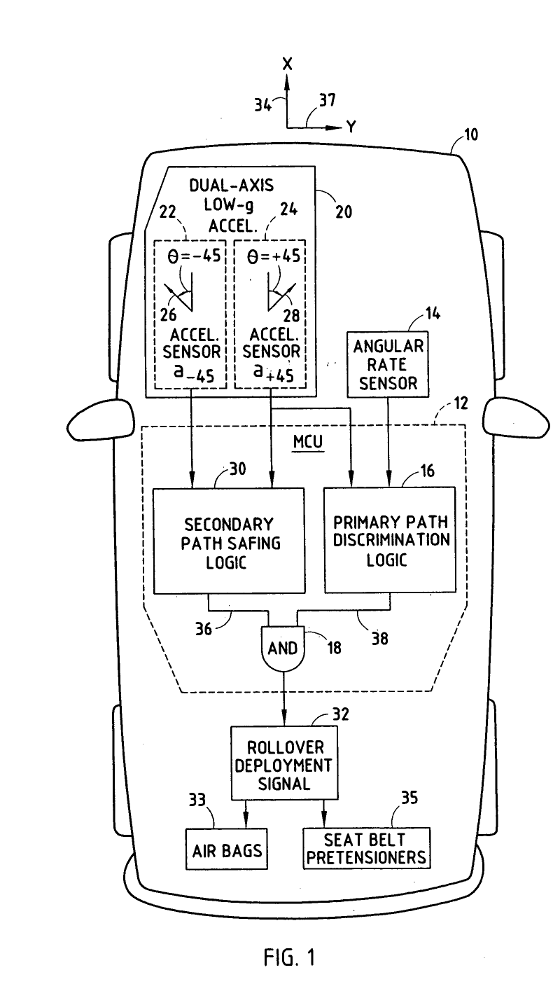

Referring to FIG. 1, a vehicle 10 is generally shown equipped with a rollover sensing apparatus for detecting an anticipated overturn condition, such as a rollover event of the vehicle 10. The rollover sensing apparatus of the present invention may be mounted as a module on the automotive vehicle 10 and detects, in advance, an impending rollover event (condition) of the vehicle 10. A vehicle rollover condition, as explained herein in connection with the present invention may include side-to-side rotation of the vehicle 10 about a longitudinal axis 34 (shown as the X-axis) of the vehicle 10, commonly referred to as “vehicle rollover,” or back-to-front rotation of the vehicle 10 about the vehicle lateral axis 37 (shown as the Y-axis which is orthogonal to the longitudinal axis 34), commonly referred to as a “vehicle pitchover,” or a combination of rollover and pitchover. For purposes of describing the rollover sensing of the present invention, the term “rollover” is generally used to refer to either a rollover condition or a pitchover condition.

The rollover sensing apparatus is designed to be located on the automotive vehicle 10 to sense vehicle dynamics, particularly longitudinal and lateral components of accelerations and one or more further vehicle roll characteristics, such as an angular rate (velocity) of the vehicle 10, according to one example. Included in the rollover sensing apparatus is a primary sensor, shown as an angular rate sensor 14, which may include a roll rate sensor for sensing an angular roll rate about the longitudinal axis 34 of the vehicle 10, a pitch rate sensor for sensing angular pitch about the lateral axis 37 of the vehicle 10, or both roll and pitch rate sensors.

The vehicle rollover sensing apparatus, according to one embodiment of the present invention, employs a dual-axis low-g accelerometer 20. Accelerometer 20 includes a first acceleration sensor 22 oriented in a first axis 26 at an angle θ offset from the longitudinal axis 34 and lateral axis 37 of vehicle 10. Sensor 22 is shown oriented at angle θ=−45 degrees from the longitudinal axis 34 and generates a first linear acceleration signal a₋₄₅. Additionally, the accelerometer 20 includes a second acceleration sensor 24 oriented in a second axis 28 at angle θ offset from the longitudinal axis 34 and lateral axis 37 of the vehicle 10. Sensor 24 is shown oriented at angle θ=+45 degrees from longitudinal axis 34 and generates a second linear acceleration signal a₊₄₅. Thus, in the embodiment shown sensors 22 and 24 are arranged orthogonal to each other offset from the longitudinal axis 34 and lateral axis 37 of the vehicle 10.

It should be appreciated that the dual-axis low-g accelerometer 20 advantageously senses linear acceleration about the first and second axes 26 and 28. By orienting each of the sensors 22 and 24 at an angle θ such that first and second axes 26 and 28 are offset from the longitudinal axis 34 and lateral axis 37 of the vehicle 10, each of the acceleration sensors 22 and 24 provides longitudinal and lateral components aₓ and a_{y} of acceleration. According to one example, the accelerometer 20 may include a dual-axis ±2 g linear accelerometer such as Model No. ADXL202 or Model No. ADXL203, both commercially available from Analog Devices, Inc.

The vehicle rollover sensing apparatus includes a controller, shown as microprocessor control unit (MCU) 12, having a microprocessor and memory. The vehicle rollover sensing apparatus further includes primary path discrimination logic 16, secondary path safing logic 30, and deployment control logic 18 in the form of a logic AND gate. The controller 12 processes the primary path discrimination logic 16, secondary path safing logic 30, and deployment control logic 18.

The primary path discrimination logic 16 may include any of a number of discrimination logic routines for processing one or more sensed roll-related characteristics of the vehicle 10 and determining a primary rollover discrimination signal 38. One example of primary path discrimination logic 16 is disclosed in U.S. Pat. No. 6,542,792, assigned to the Assignee of the present application, the entire disclosure of which is hereby incorporated herein by reference. In the embodiment shown, the primary path discrimination logic 16 processes the angular rate sensor 14 using an integrator and control logic to generate a discrimination signal 38 for use in determining the vehicle rollover deployment signal 32.

The vehicle rollover detection of the present invention employs secondary path safing logic 30 for generating a safing signal 36, which is logically ANDed with the discrimination signal 38 to generate the rollover deployment signal 32. The safing signal 36 provides a redundancy check prior to deploying one or more restraint devices, such as air bags 33 and seatbelt pretensioners 35. It should be appreciated that any of a number of restraint devices, in addition to the air bags 33 and seatbelt pretensioners 35, may be deployed in response to the rollover deployment signal 32.

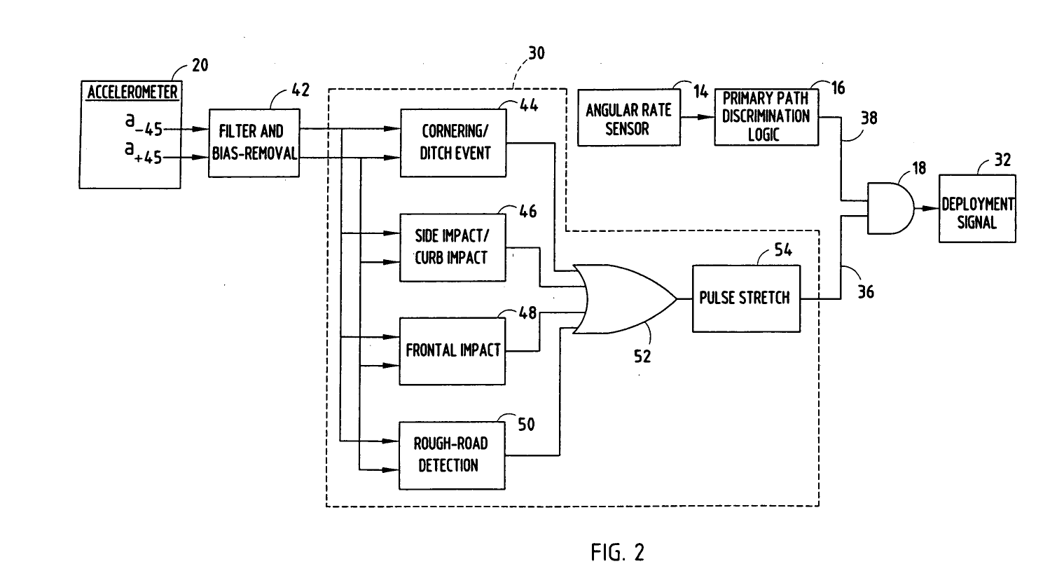

Referring to FIG. 2, the sensed acceleration signals a₋₄₅ and a₊₄₅ generated by sensors 22 and 24 of accelerometer 20 are processed by filter and bias-removal logic 42. The filter and bias-removal logic 42 removes unwanted bias and noise associated with the individual sensed acceleration signals a₋₄₅ and a₊₄₅. This may include removing constant and slowly-varying offset bias.

The secondary path safing logic 30 receives the filtered and bias-removed acceleration signals a₋₄₅ and a₊₄₅, processes the longitudinal and lateral components of acceleration aₓ and a_{y}, and generates the safing signal 36. In particular, the safing logic 30 compares the longitudinal and lateral components of acceleration from one or both of acceleration signals a₋₄₅ and a₊₄₅ to predetermined threshold values. The threshold values are threshold indicators of certain events.

The safing logic 30 includes logic for detecting several vehicle driving events including cornering/ditch event 44, side impact/curb event 46, frontal impact event 48, and rough road event detection 50. Safing logic 30 detects the presence of one or more of events 44 through 50 by comparing select longitudinal and lateral components of acceleration to the predetermined threshold values. In response to detecting the presence of any of the events 44 through 50, an output signal is provided as an input to the logic OR gate 52. Any one of the events 44 through 50 being detected generates an output via logic OR gate 52 to a pulse stretch 54. The pulse stretch 54 latches the output of the logic OR gate 52 for a set time period to set the safing signal 36 for the duration of the time period such that the detection of the discriminating signal 38 during that time period results in control logic AND gate 18 generating a rollover deployment signal 32.

The safing logic 30 is implemented as software, processed by a microprocessor and memory in the controller 12 according to the embodiment shown and described herein. However, it should be appreciated that safing logic 30 may be implemented by analog and/or other digital circuitry.

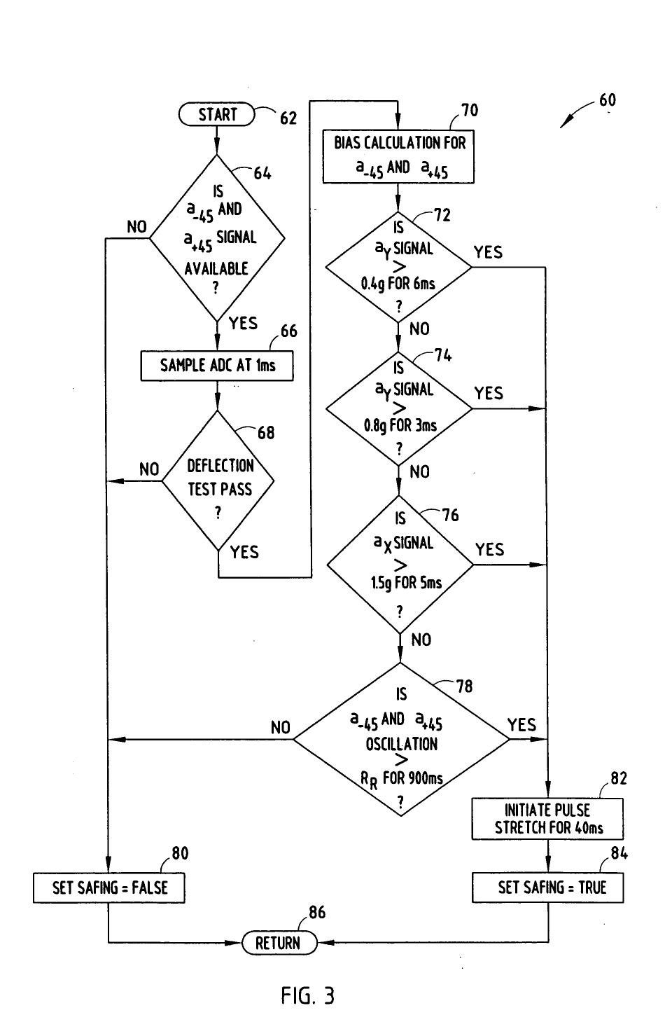

A method 60 of implementing the safing logic 30 is illustrated in FIG. 3, according to one embodiment. Safing logic method 60 begins at step 62 and proceeds to decision step 64 to determine if the first and second acceleration signals a₋₄₅ and a₊₄₅ are both available. If both acceleration signals a₋₄₅ and a₊₄₅ are not available, method 60 sets a safing flag to false in step 80, before returning in step 86. Provided both acceleration signals a₋₄₅ and a₊₄₅ are available, method 60 proceeds to step 66 to sample the analog-to-digital converted (ADC) signals at one millisecond (1 ms) intervals. Next, decision step 68 checks for whether a deflection self-test is passed and, if not, sets the safing flag to false in step 80, before returning in step 86 to repeat the method 60. If the deflection self-test has passed, routine 60 proceeds to perform bias calculation for acceleration signals a₋₄₅ and a₊₄₅ in step 70.

Following the bias calculation step, method 60 checks for a cornering/ditch event in decision step 72. This includes comparing the lateral component of acceleration a_{y} from one or both of acceleration signals a₋₄₅ and a₊₄₅ to a threshold value, and determining if the lateral component of acceleration a_{y} is greater than a predetermined threshold value, such as 0.4 g, for a time interval of 6 milliseconds. If a cornering/ditch event is detected, method 60 sets the pulse stretch for 40 milliseconds in step 82 and then sets a safing flag to true in step 84. The setting of the safing flag to true generates the safing signal which allows for deployment of restraint devices, provided the primary rollover discrimination signal is also present at some point during the pulse stretch time period. The safing flag returns to false after the 40 millisecond pulse stretch has expired, and the routine returns in step 86.

Next, method 60 checks for a side/curb impact in decision step 74. Decision step 74 includes comparing the lateral component of acceleration a_{y} from one or both of signals a₋₄₅ and a₊₄₅ to a threshold value, and determining if the lateral component of acceleration a_{y} is greater than a predetermined value, such as 0.8 g, for a time interval of 3 milliseconds. If a side/curb impact event is detected, method 60 sets the pulse stretch for 40 milliseconds in step 82, and then sets a safing flag to true in step 84 which allows for deployment of restraint devices, provided the primary rollover discrimination signal is also present at some point during the pulse stretch time period.

Method 60 also checks for a frontal impact event (front collision) in decision step 76. Decision step 76 compares the longitudinal component of acceleration aₓ from one or both of signals a₋₄₅ and a₊₄₅ to a threshold value and determines if the longitudinal component of acceleration aₓ is greater than a predetermined value, such as 1.5 g, for a 5 millisecond time period. If a frontal impact is detected, method 60 proceeds to step 82 to set the pulse stretch to 40 milliseconds and then to step 84 to set the safing flag equal to true to generate the safing signal.

Method 60 further checks for a rough road condition in decision step 78. Decision step 78 includes comparing one or both of first and second acceleration signals a₋₄₅ and a₊₄₅ from sensors 22 and 24 and determining whether the first and second acceleration signals a₋₄₅ and a₊₄₅ provides an oscillation in the form of a change in acceleration greater than a value R_{R} for a 900 millisecond time period. If a rough road condition is detected, method 60 proceeds to set the pulse stretch equal to 40 milliseconds in step 82 and then sets the safing flag equal to true in step 84 to generate the safing signal, before returning at step 86.

Accordingly, safing logic method 60 checks for the presence of any of several vehicle driving events including a cornering/ditch event, side impact/curb event, frontal impact, and rough road detection, and generates a safing signal in response to detecting any one or more of these events. This enables the vehicle rollover detection apparatus to deploy restraint devices provided the safing signal and primary vehicle rollover discrimination signal are both present.

It should be appreciated that while the vehicle rollover sensing apparatus and method of the present invention advantageously provides for a safing function for use in detecting a vehicle rollover condition and deploying restraint devices, the safing logic 30 may also be employed to determine a vehicle rollover event, without using the discrimination signal. As such, the present invention is not intended to be limited to a safing function, unless expressly provided for in the claims.

It will be understood by those who practice the invention and those skilled in the art, that various modifications and improvements may be made to the invention without departing from the spirit of the disclosed concept.

The scope of protection afforded is to be determined by the claims and by the breadth of interpretation allowed by law.

1. A vehicle rollover sensing apparatus for generating a safing signal, said rollover sensing apparatus comprising:
an accelerometer located on a vehicle and comprising a first acceleration sensor oriented in a first axis at an angle offset from the longitudinal axis and lateral axis of the vehicle, said accelerometer sensing a longitudinal component of acceleration of the vehicle and a lateral component of acceleration of the vehicle; and
control logic for receiving the sensed acceleration signal and generating a safing signal as a function of at least one of the longitudinal and lateral components of acceleration.

2. The rollover sensing apparatus as defined in claim 1, wherein the accelerometer further comprises a second acceleration sensor located on the vehicle and oriented in a second axis at an angle offset from the longitudinal axis and lateral axis of the vehicle, said second acceleration sensor sensing a longitudinal component of acceleration of the vehicle and a lateral component of acceleration of the vehicle.

3. The rollover sensing apparatus as defined in claim 2, wherein the accelerometer comprises a dual-axis accelerometer providing the first and second acceleration sensors for providing the first and second acceleration signals.

4. The vehicle rollover apparatus as defined in claim 3, wherein the dual-axis accelerometer comprises a low-g accelerometer.

5. The rollover sensing apparatus as defined in claim 2, wherein the first and second accelerometer sensors are oriented such that the first axis is substantially orthogonal to the second axis.

6. The rollover sensing apparatus as defined in claim 5, wherein the first axis is oriented at an angle approximately 45 degrees relative to the longitudinal axis of the vehicle, and a second axis is oriented at an angle approximately 45 degrees relative to the longitudinal axis of the vehicle.

7. The rollover sensing apparatus as defined in claim 1, wherein the safing signal is processed with a rollover discrimination signal to generate a vehicle overturn condition signal as a function of the rollover discrimination signal and the safing signal.

8. The rollover sensing apparatus as defined in claim 7, wherein the overturn condition is a vehicle rollover about the longitudinal axis of the vehicle.

9. The rollover sensing apparatus as defined in claim 1, wherein said roll arming logic compares at least one of the longitudinal and lateral components of acceleration to a threshold value.

10. A rollover sensing apparatus for detecting an anticipated overturn condition for a vehicle, said apparatus comprising:
at least one sensor located on a vehicle for detecting a vehicle roll characteristic;
rollover discrimination logic for generating a rollover discrimination signal;
an accelerometer located on a vehicle and comprising a first acceleration sensor oriented in a first axis at an angle offset from the longitudinal and lateral axes of the vehicle, said accelerometer sensing a longitudinal component of acceleration of the vehicle and a lateral component of acceleration of the vehicle;
safing logic for processing the sensed acceleration signal and generating a safing signal as a function of at least one of the longitudinal and lateral acceleration components; and
control logic for processing the discrimination signal and safing signal and generating a vehicle rollover output signal.

11. The rollover sensing apparatus as defined in claim 10, wherein the apparatus further comprises a second acceleration sensor located on the vehicle and oriented in a second axis at an angle offset from the longitudinal axis and lateral axis of the vehicle, said second acceleration sensor sensing a longitudinal component of acceleration of the vehicle and a lateral component of acceleration of the vehicle.

12. The rollover sensing apparatus as defined in claim 11, wherein the accelerometer comprises a dual-axis accelerometer providing the first and second acceleration sensors.

13. The vehicle rollover apparatus as defined in claim 12, wherein the dual-axis accelerometer comprises a low-g accelerometer.

14. The rollover sensing apparatus as defined in claim 11, wherein the first and second acceleration sensors are oriented such that the first axis is substantially orthogonal to the second axis.

15. The rollover sensing apparatus as defined in claim 14, wherein the first axis is oriented at an angle of approximately 45 degrees relative to the longitudinal axis of the vehicle, and a second axis is oriented at approximately 45 degrees relative to the longitudinal axis of the vehicle.

16. The rollover sensing apparatus as defined in claim 10, wherein said control logic comprises a logic AND gate.

17. The rollover sensing apparatus as defined in claim 10, wherein said rollover sensing apparatus determines a rollover condition of the vehicle about the longitudinal axis of the vehicle.

18. The rollover sensing apparatus as defined in claim 10, wherein said control logic compares at least one of the longitudinal and lateral components of acceleration to a threshold value.

19. A method of generating a safing signal for use in detecting a vehicle rollover, said method comprising the steps of:
sensing longitudinal and lateral components of acceleration of a vehicle via a first acceleration sensor located on the vehicle and oriented in a first axis at an angle offset from the longitudinal axis and lateral axis of the vehicle; and
generating a safing signal as a function of at least one of the sensed longitudinal and lateral components of acceleration.

20. The method as defined in claim 19 further comprising the step of sensing longitudinal and lateral components of acceleration of the vehicle via a second acceleration sensor located on the vehicle and oriented in a second axis at an angle offset from the longitudinal axis and lateral axis of the vehicle, wherein the safing signal is generated as a function of at least one of the sensed longitudinal and lateral components of acceleration generated by at least one of the first and second acceleration sensors.

21. The method as defined in claim 20, wherein the steps of sensing longitudinal and lateral acceleration of the vehicle via the first and second acceleration sensors comprises sensing longitudinal and lateral components of acceleration via a dual-axis accelerometer.

22. The method as defined in claim 20, wherein the first and second acceleration sensors are oriented substantially orthogonal to each other.

23. The method as defined in claim 19 further comprising the step of determining a vehicle rollover event as a function of the safing signal.

24. The method as defined in claim 19 further comprising the step of processing the safing signal with a rollover discrimination signal to generate a vehicle overturn condition deployment signal as a function of the rollover discrimination signal and the safing signal.

25. The method as defined in claim 19, wherein the overturn condition is a vehicle rollover about the longitudinal axis of the vehicle.

26. The method as defined in claim 19 further comprising the step of comparing at least one of the longitudinal and lateral components of acceleration to a threshold value to determine the safing signal.
